(19) United States
(12) Patent Application Publication
(10) Pub. No.: US 2014/0089106 A1
(43) Pub. Date: Mar. 27, 2014

(54) METHOD AND SYSTEM FOR FORMULATING BIDS FOR INTERNET ADVERTISING USING FORECAST DATA

(71) Applicant: YAHOO! INC., Sunnyvale, CA (US)

(72) Inventors: Patrick Jordan, Mountain View, CA (US); Prabhakar Krishnamurthy, Pleasanton, CA (US); Mohammad Mahdian, Santa Clara, CA (US); Sergei Vassilvitskii, New York, NY (US)

(73) Assignee: Yahoo! Inc., Sunnyvale, CA (US)

(21) Appl. No.: 13/629,413

(22) Filed: Sep. 27, 2012

(51) Int. Cl. G06Q 30/02

(52) U.S. Cl. 705/14.71

(57) ABSTRACT

A system and method for formulating a bid on an impression for an Internet advertising campaign using market forecast data are provided. The system and method comprise determining a bid policy using an advertiser goal type, an advertiser payment type, and a budget parameter. Historical impression data pertaining to the advertising campaign is sampled using any applicable sampling technique. The sampled data is used to derive forecast data that predicts the future state of the market. The bid policy and the forecast data are used to derive a spend curve, from which an optimal bid is formulated that results in a proper and efficient allocation of the advertiser's budget.

### FIELD OF THE INVENTION

The embodiments described herein relate to Internet advertising exchanges. Specifically, the embodiments provide a technique for optimizing advertiser bids that incorporates forecasts of the future state of the market within the exchange.

### BACKGROUND

The Internet is now a ubiquitous medium of communication in most parts of the world. The emergence of the Internet has opened a new forum for the creation and placement of advertisements promoting products, services, and brands. Internet content providers rely on advertising revenue to drive the production of free or low-cost content. Advertisers, in turn, increasingly view Internet content portals and online publications as a critically important medium for the placement of advertising. Thus, the sale and purchase of Internet advertising impressions has evolved into a multibillion-dollar a year industry.

Early in the history of Internet advertising, advertisers seeking to purchase inventory sought out individual publishers. Advertisers considered a publisher's inventory (impressions per unit time) and typical population demographics when deciding whether to make a bulk purchase. As advertisers' appetite for volume and reach (fraction of some population) increased, publishers were no longer able to singly fulfill these needs. This gave rise to advertising networks, where multiple advertisers and publishers came together to buy and sell inventory. Advertising networks facilitate various types of transactions, including guaranteed and non-guaranteed contracts.

Typically, advertisers (e.g., buyers of ad space) and online publishers (sellers of ad space) have agreements with one or more advertising networks, which provide for serving an advertiser's banner or advertisement across multiple publishers, and concomitantly provide for each publisher having access to a large number of advertisers. Advertising networks, which may also manage payment and reporting, may also attempt to target certain Internet users with particular advertisements to increase the likelihood that the user will take an action with respect to the advertisement. From an advertiser's perspective, effective targeting is important for achieving a high return on investment (ROI).

As advertisers' need for volume and reach increased further still, internetwork purchases started to take shape. Further, rather than buying a fixed amount of inventory in bulk, many advertisers only wanted to buy inventory that met certain performance goals. Advertising exchanges were developed to address this need. Advertising exchanges aim to provide a high degree of trading efficiency by bringing together a large number of buyers and sellers. Such exchanges are typically focused on directly matching the bids and offers of buyers and sellers. Conventional transactions on these exchanges are typically between (i) buyers and sellers, (ii) intermediaries (e.g., brokers, which may be a buyer or seller), or (iii) buyers or sellers and intermediaries. One such exchange, the Right Media Exchange (RMX), processes billions of impressions per day.

The emergence of such exchanges has presented advertisers, brokers, and other entities seeking to purchase advertising inventory with the challenge of formulating an effective bidding strategy. Advertisers typically have limited advertising budgets, and decisions on allocating advertising resources must be made carefully and intelligently. If bids are excessively high, the advertiser's budget will be exhausted prematurely. If bids are excessively low, the advertiser will not achieve an effective amount of exposure for the product or brand. In addition, the pricing patterns of advertising exchanges are similar to those of any open market for goods and services: prices often fluctuate based on available quantity and demand. Thus, there is a need for a technique that allows advertisers to formulate an optimal bidding strategy based on forecasts of the future state of the market within the advertising exchange. As will be shown, the embodiments disclosed herein provide such a technique in an elegant manner.

### SUMMARY OF THE INVENTION

[BASED ON FINAL CLAIM SET]

### BRIEF DESCRIPTION OF THE DRAWINGS

FIG. 1 depicts a diagram illustrating an advertisement delivery system according to an embodiment.

FIG. 2 depicts a diagram illustrating an advertisement delivery system according to an embodiment.

FIG. 3 depicts a flowchart illustrating a procedure for formulating a bid using forecast data according to an embodiment.

FIG. 4 depicts a table illustrating each type of advertising campaign and its associated payment type and goal type according to an embodiment.

FIG. 5 depicts a list of example advertising campaigns according to an embodiment.

FIG. 6 depicts a flowchart illustrating a procedure for formulating a bid policy according to an embodiment.

FIG. 7 depicts a flowchart illustrating a parameter optimization process incorporating Monte Carlo sampling according to an embodiment.

FIG. 8 depicts a flowchart illustrating a procedure for forecasting sampling weights according to an embodiment.

FIG. 9 depicts a diagram illustrating an exemplary environment within which some embodiments may operate.

FIG. 10 depicts a diagram illustrating an exemplary computing system according to an embodiment.

### DETAILED DESCRIPTION

The embodiments of the advertising system are described using a number of terms. In order to aid in clarity, some definitions of the terms used to describe these embodiments follow. However, these terms define general concepts, and thus are not to be construed narrowly. A publisher is generally defined as a Web site that has inventory for the delivery of advertisements. As such, advertisements are displayed on the Web pages of the publisher's Web site. Users are generally defined as those individuals that access Web pages through use of a browser. However, the term user may also be used to describe entities that use the advertising exchange system, such as users that access an application on the advertising exchange system to set parameters. Various participants of the advertising exchange system are referred to as “entities.” Thus, the term entity is generally used to describe any number of participants of the advertising exchange system. Those participants include advertisers, publishers, advertising networks and integrator networks.

An advertising network typically integrates entities, such as advertisers and publishers. An advertising network typically operates in conjunction with advertisers and publishers in order to deliver ads, from one or more advertisers, to Web pages of one or more publishers. For example, Yahoo! Inc, the assignee of the present invention, operates such an advertising network.

An integrator network entity generally defines a participant of the advertising exchange system that represents or integrates one or more entities on the advertising exchange system (e.g., advertisers, publishers, advertising networks, etc.). For example, an integrator network may represent advertisers on the advertising exchange system in order to deliver advertisements to publishers, advertising networks and other integrator networks. In some embodiments, the integrator networks are referred to as the “users” of the advertising exchange system. The integrated networks may comprise third party agents that operate on behalf of or are part of the integrator network. The term “third party agent” is used to generally describe an agent or customer that participates in transactions on the advertising exchange system. Similarly, the term “third party recipient” is used to describe a user or participant of the advertising exchange system that receives information from the system, such as bid requests. However, the terms integrator networks, third party agents and third party recipients are intended to represent a broad class of entities, including publishers, advertisers and networks, as well as the agents that represent them, that operate on the advertising exchange system.

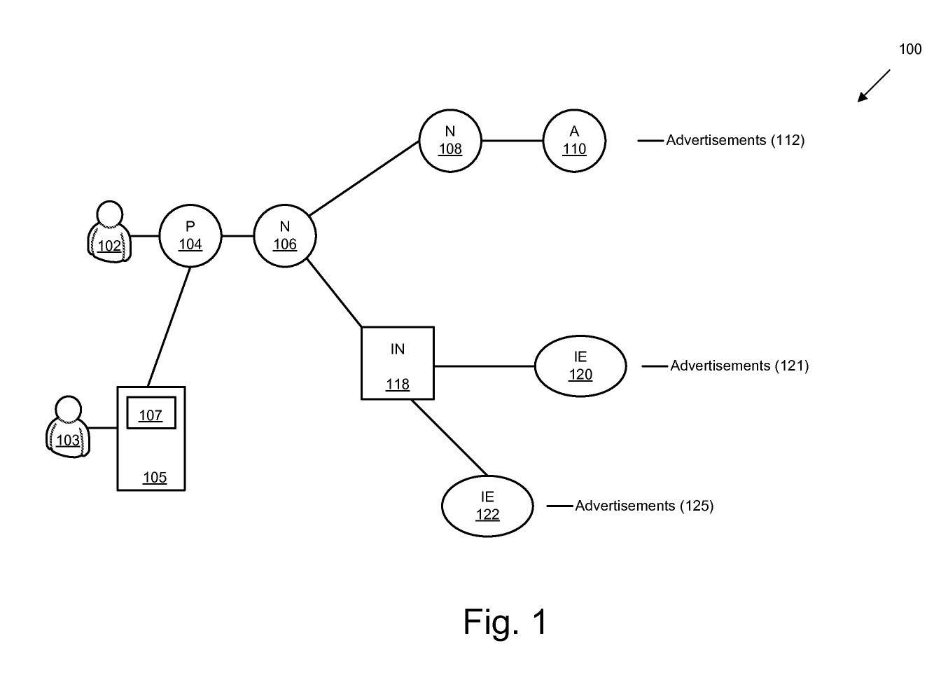

FIG. 1 illustrates one embodiment of an advertisement delivery system. As shown in FIG. 1, the system 100 includes a variety of entities such as users 102 and 103, one or more publishers 104, networks 106 and 108, and/or advertisers 110. The system 100 further includes one or more integrator networks (IN) 118 that have one or more integrated entities (IE) 120 and 122. The various entities including users, publishers, networks, advertisers, integrator networks and integrated entities illustrated in FIG. 1 are merely exemplary, and one of ordinary skill recognizes that the system 100 may include large numbers of entities. Moreover, the various entities are coupled together in different advantageous configurations such as, for example, the exemplary configuration illustrated in FIG. 1.

The user 103 accesses information and/or content provided by the publisher 104. One form of access may include a browser 105 that has inventory locations 107 for the presentation of advertising. In one embodiment, an advertisement call is generated that requests an advertisement, from advertisements 112, 120 and 121, for placement with the inventory location 107. The corresponding advertisement may be delivered to publisher 104 by one or more networks. For instance, in one example, the network 106 is coupled to the publisher 104, and the network 108 is coupled to the advertiser 110. For this example, the networks 106 and 108 are coupled to each other. The advertiser 110 generally has one or more ad campaigns each comprising one or more advertisements 112 that the advertiser 110 wishes to place with the inventory of publishers such as, for example, the inventory location 107 of the publisher 104 that is presented to the user 103 via the browser application 105.

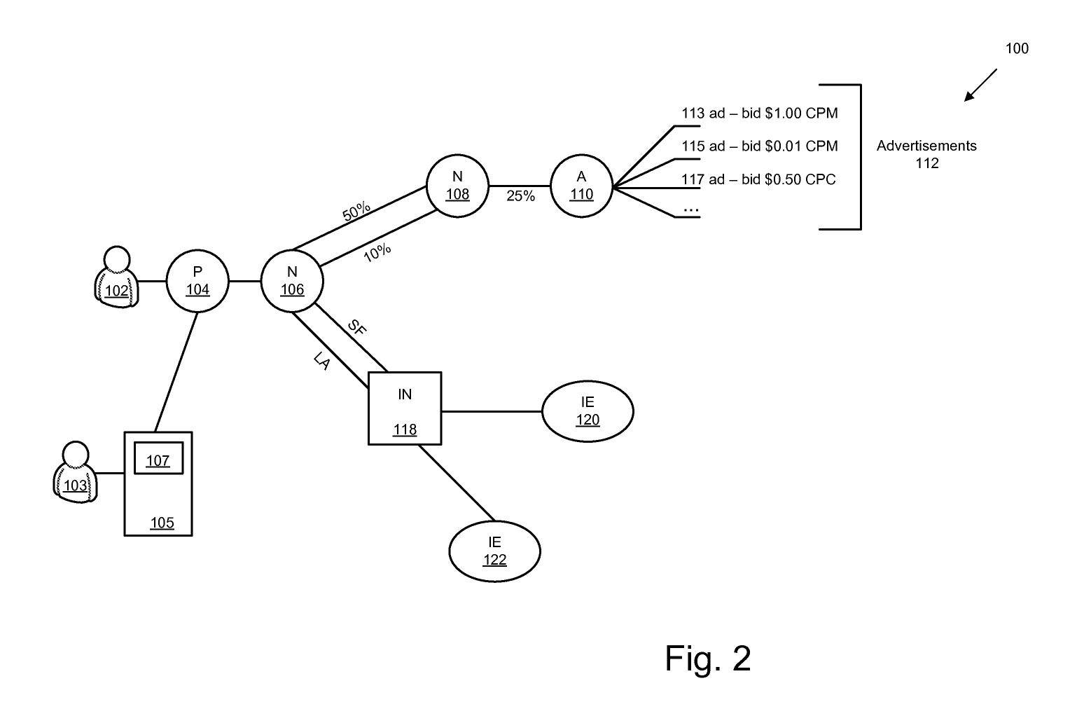

FIG. 2 illustrates another embodiment of an ad delivery system. For this example, the advertisements 113, 115, and 117 generally each have an associated bid that the advertiser 110 will pay for the placement of the advertisement with the inventory and for presentation to the user(s). For this example, the advertisement 113 has a bid of $1.00 cost per thousand page impressions (“CPM”), the advertisement 115 has a bid of $0.01 CPM, and the advertisement 116 has a bid of $0.50 cost per click (“CPC”). One of ordinary skill recognizes different types of bids such as, for example, CPM, CPC, cost per action (“CPA”), and others. Some systems normalize the advertisement bids to CPM.

For the example illustrated in FIG. 2, the entities along the chain of distribution for the advertisements have various revenue sharing agreements. In this example, the network 108 has a 25% revenue sharing agreement with the network 106 for fees paid by the advertiser 110. Similarly, the network 106 has 50% and 10% revenue sharing agreements with the publisher 104 for fees paid to the network 106 by way of the network 108. The multiple revenue sharing agreements between entities may be for different campaigns and/or for targeting different segments of users. For example, the 50% revenue sharing agreement between networks 108 and 106 may be used to target a user segment that includes males under 40 years old, who have an interest in sports. In another example illustrated in FIG. 2, the 10% revenue sharing agreement may be used to target females, over 30 years old, who have an interest in gardening. For these examples, network 108 delivers users of the target segment to network 106, and network 106 is the exclusive representative of the publisher 104. One of ordinary skill recognizes many different payment and/or targeting schemes.

As noted above, Internet advertising is typically sold by impression, click, or action. An impression is a single instance of an advertisement being displayed before an Internet user. In the context of an advertising exchange, an impression is an opportunity to transmit an advertisement to a user. The impression, including its attributes (e.g., page content, demographic data of the user, etc), is presented to the entities that participate in the exchange. An advertiser or other entity can place a bid on the impression. The exchange evaluates all of the bids and awards the impression to the winning bid. Due to the sheer volume of impressions and publishers within an exchange, advertisers often employ bidding agents that automatically place bids and purchase impressions based on a pre-determined strategy. In many prior art techniques for formulating a bidding strategy, bids are determined solely on the basis of the advertiser's goals and the current market state within the advertising exchange.

However, the market rates of the various types of impressions that are offered for sale within an advertising exchange may fluctuate wildly based on availability, bidding activity, and various other factors. A particular type of impression may currently command a higher or lower bid than it would in the future. If the impression is likely to command a lower bid in the future, the advertiser may wish to reduce its current bid. If the impression is likely to command a higher bid in the future, the advertiser may wish to increase its current bid. Thus, an awareness of this future state of the market would allow an advertiser to further optimize its bidding strategy and thereby allocate its advertising budget more efficiently. The embodiments disclosed herein provide a technique for forecasting the future state of the market and generating bids that take this forecast into account.

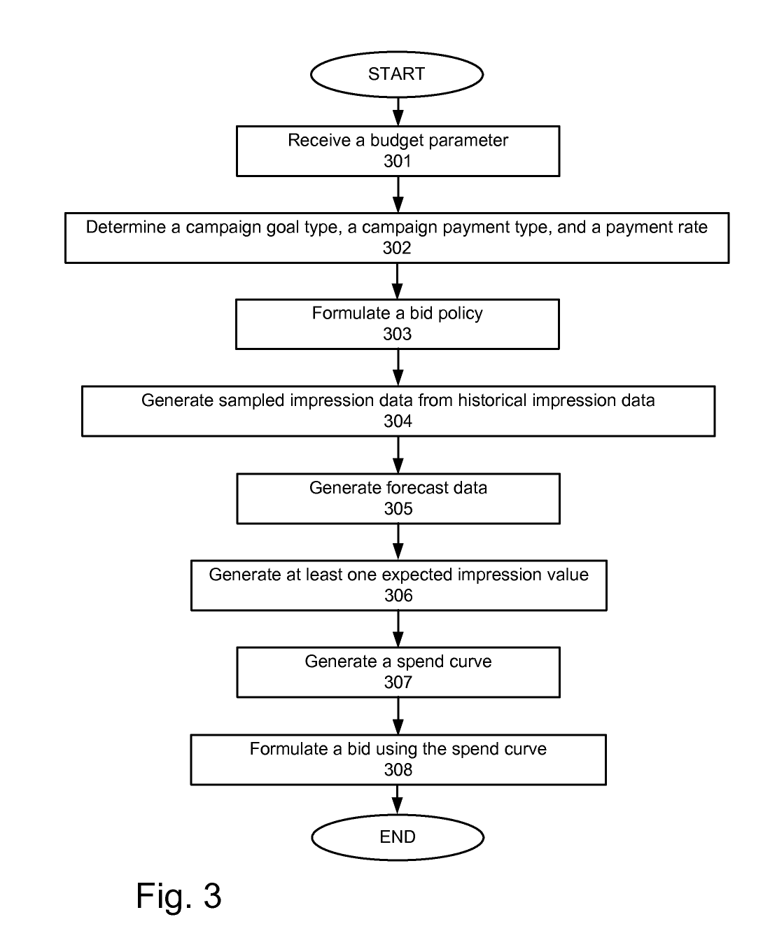

An example embodiment is illustrated by the flow diagram 300 depicted in FIG. 3. At step 301, a budget parameter is received. The budget may correspond to funds allocated for a particular length of time. For example, a monthly budget, a quarterly budget, or a yearly budget may be used. Any length of time for the budget may be used without deviating from the spirit or scope of the invention. At step 302, a campaign goal type, a campaign payment type, and a payment rate are determined. The campaign goal type and campaign payment type may correspond to cost per impression, cost per click, or cost per action. Any measure for the campaign goal type and campaign payment type may be used without deviating from the spirit or scope of the invention. At step 303, a bid policy is formulated using the campaign goal type, the campaign payment type, the payment rate, and the budget parameter. At step 304, sampled impression data is generated from historical impression data. The sampled impression data comprises a subset of all of the impressions purchased throughout the history of an advertising campaign. This data serves as the basis for forecasting the future state of the market. At step 305, forecast data is generated using the sampled impression data. At step 306, at least one expected impression value is generated using the sampled impression data and the forecast data. An expected impression value corresponds to how valuable the impression is to the advertiser. This value may be further be determined by estimating the probability that a user will click on an advertisement. At step 307, a spend curve is generated using the expected impression value, the bid policy, and the budget parameter. At step 308, a bid is formulated using the spend curve, and the method concludes.

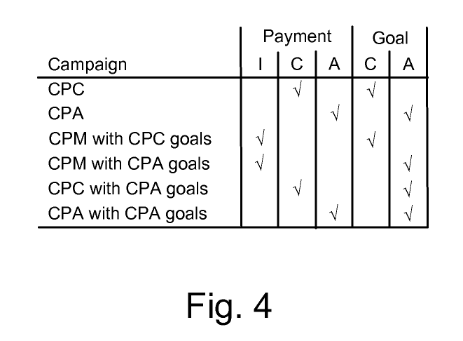

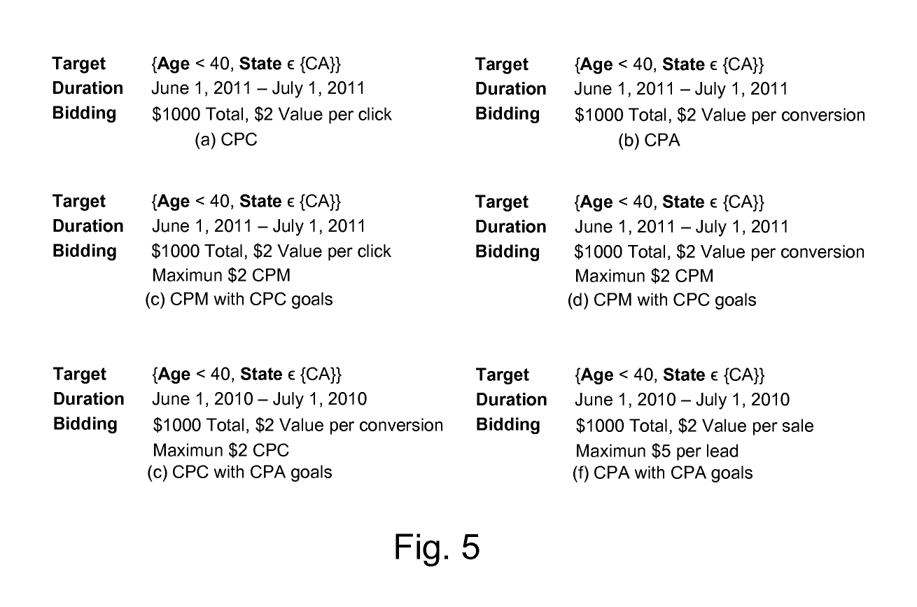

The costs of Internet advertising campaign are usually analyzed in terms of cost per impression (CPM), cost per click (CPC), or cost per action (CPA). Internet advertising campaigns may be classified by payment type and goal type. Payment type refers to an event for which the advertiser is willing to pay: advertisers may pay per impression in CPM, per click in CPC, and per action in CPA. Goal type refers to the set of events that advertisers value: clicks in CPC and actions in CPA. For instance, in a CPM with CPC goals campaign, the advertiser pays per impression but profits on a click. Advertisers specify a maximum payment associated with the payment event and a value associated with each goal event. Multiple goal events and associated values can be specified. FIG. 4 depicts a table illustrating each advertising campaign and its associated payment type and goal type, and FIG. 5 depicts a list of example advertising campaigns.

According to one series of embodiments, for each matched opportunity to bid on an impression, a bidding agent generates a bid for a campaign. The bid is generated through an optimization process that has both online and offline components. The offline component generates a set of bid parameters, akin to dual variables, and the online component generates a bid from the bid parameters, campaign constraints, and action-rate predictions. In this series of embodiments, advertisers select bids (or bid policies) in order to maximize value subject to a budget constraint and (possibly) a maximum bid constraint. Because advertisers specify the value they receive for each goal, the expected value per impression can be calculated as:

$$v = {\sum }_{g ∈ Goals} {λ}_{g} {v}_{g} \qquad ( Equation 1 )$$

where λ_{g} is the prediction of the rate at which action g will occur. In this embodiment, an additive function is used for the total expected value. This is because either of the following assumptions may be made: a) the goal actions are independent, or b) if the goal actions are not independent, then marginal values are specified for each action.

One objective in this series of embodiments is to generate a family of bidding policies that produce bids given information about goal actions, their values, predicted rates, and the predicted rate of the payment action for each impression. Thus, a bid policy, b(v,λ) is a function of the expected-value-per-impression, v, and the payment rate, λ>0, for each impression. In one such embodiment, the auction is assumed to be a second-price auction where the winner pays the second-highest bid and a prediction of the highest competitive bid p is available. An advertiser's effective bid (eCPM) must exceed p in order to win the auction. The advertiser pays p (the expected value of p if it is a distribution) if it wins the auction. The expected profit of a bidding policy may be given by the functional:

Π[b]q∫₀^{∞}∫₀^{∞}₀^{λb(v,λ)}(v−p)f(v,λ,p)dpdvdλ (Equation 2)

where f is the joint density function of v, λ, the highest competitive bid p, and the quantity q. The deterministic approximation problem (DAP) is formulated as:

$$\begin{matrix}{max}_{b} & Π [ b ] \\ s . t . & S [ b ] \leq B \\ b ( v , λ ) \leq {b}_{max} & ∀ v \geq 0 , λ > 0\end{matrix} \qquad ( Equation 3 )$$

where bₘₐₓ is the maximum-bid constraint and B is the budget. Solving the Euler-Lagrange equations characterizes the optimal bid policy as a single parameter, b*:

$$b ( v , λ ; {b}^{*} ) = \{ \begin{matrix}\frac{v}{λ} {b}^{*} , & if {vb}^{*} \leq λ {b}_{max} , \\ {b}_{max} , & otherwise ,\end{matrix} \qquad ( Equation 4 )$$

where b*ε[0,1]. The optimal b* solves

S(b*)=B (Equation 5)

where S(b*)=S[b(b*)], if the constraints are active at the maximum. In order to avoid overshooting the budget B, according to one embodiment, an online budget management system is employed to monitor spending and ensure that it does not exceed the budget. According to another embodiment, the algorithm iteratively solves for the optimal policy over time; as the remaining budget shrinks, the overshoot becomes smaller and smaller. Any technique for ensuring that the budget is not exceeded may be used without deviating from the spirit or scope of the invention.

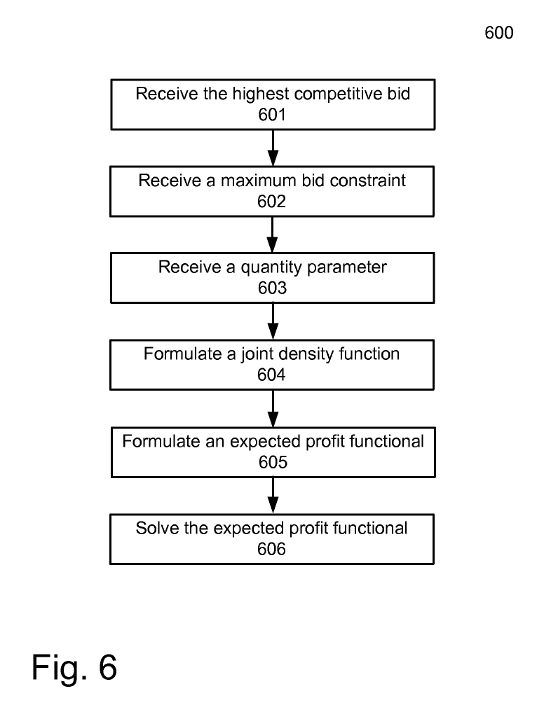

A procedure for formulating a bid policy according to an embodiment is illustrated by the flow diagram 600 depicted in FIG. 6. At step 601, the highest competitive bid is received. At step 602, a maximum bid constraint is received. At step 603, a quantity parameter is received. At step 604, a joint density function is formulated using the highest competitive bid, the payment rate, an expected value variable, and the quantity parameter. At step 605, an expected profit functional is formulated using the joint density function. At step 606, the expected profit functional is solved to characterize the optimal bid policy as a single parameter. This may be performed by using an Euler-Lagrange equation. Any technique for formulating and solving the expected profit functional may be used without deviating from the spirit or scope of the invention.

An advertised optimal bidding policy may thus be represented by the single parameter b*. According to the embodiments disclosed herein, this parameter may be optimally set by accounting for the supply quantity, value, and forecasts of the future state of the market. Using these forecasts, an estimate of S(•) is derived, which is known as the spend curve. Given an estimate of the spend curve, b* is determined such that either S(b*)=B or b*=1.

According to one series of embodiments, the spend curve for a target time period is estimated using a sampling approach. As noted above, the future state of the market within an advertising exchange may be forecast by analyzing the previous impressions of an advertising campaign. This historic data is sampled and then annotated with quantity, value, and highest competitor bid (or price in the second-price auction). The quantity and highest competitor bid are forecast using independent models. Because the target time period and the time period over which historic impressions are sampled do not overlap, the models need to be able to predict how quantity and price will change over time. In this embodiment, supply quantity and prices are forecast while action rates are assumed to remain stationary conditioned on other features.

According to one such embodiment, this is performed using a Monte Carlo model, a computational approach that relies on repeated random sampling of a data set to simulate phenomena with a high degree of uncertainty. Monte Carlo models are often used in contexts with computational constraints that make exhaustive or exact calculations infeasible. In the context of an advertising exchange, each impression is unique and comprises potentially hundreds of attributes. Furthermore, an advertiser may purchase millions of impressions throughout the history of an advertising campaign. Thus, an exhaustive analysis of previous campaign impressions would require complex calculations involving massive amounts of data each time a current impression arrives for bidding. Storage and resource limitations make such calculations infeasible to perform repeatedly during the milliseconds that pass between the arrival of an impression and the placement of a bid. A Monte Carlo model allows for a compact representation of an advertising campaign's optimization parameters in the form of a single value.

More particularly, the main advantages of Monte Carlo sampling for spend-curve generation, compared to a parametric approach that explicitly characterizes each type of supply impression for a campaign, are that sampling (i) provides opportunities that are fully-qualified with the necessary attributes to apply the derived prediction algorithms (which are trained using the same set of attributes), and (ii) requires no assumptions on how the supply landscape is partitioned by the different attribute combinations.

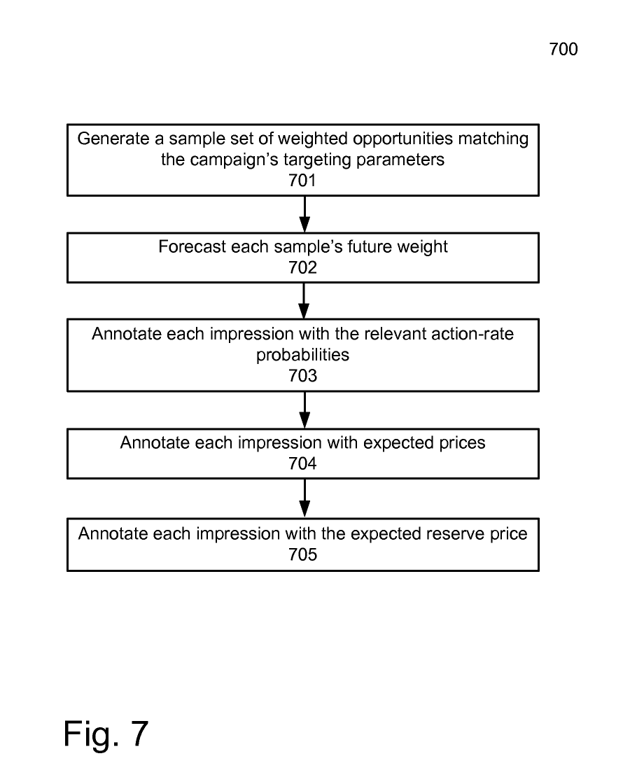

A parameter optimization process incorporating Monte Carlo sampling is illustrated according to an embodiment by the flow diagram 700 depicted in FIG. 7. At step 701, a sample set of weighted opportunities matching the campaign's targeting parameters is generated. At step 702, each sample's future weight is forecast. This forecast represents the quantity of similar impressions that the campaign should expect to see in the target time interval. At step 703, each impression is annotated with the relevant action-rate probabilities the campaign should expect to see for similar impressions. At step 704, each impression is annotated with the prices (distribution or point estimates) that are expected for similar impressions during the time interval. At step 705, each impression is annotated with the expected reserve price, and the method concludes.

Steps 701 and 702 in the flow diagram 700 correspond to step 304 in the flow diagram 300 of FIG. 3. In step 701, sampling may be stratified by campaign creative. Each campaign consists of one or more creatives, each with independent targeting constraints. A campaign can thus target different user and/or content segments using different display ads, or simply rotate between different creatives to avoid user fatigue. Stratified sampling associates a weight with each impression and ensures that 1) the overall set of weighted impressions is representative of the type and number of opportunities the campaign is expected to be matched to, and 2) each creative will be matched to a minimum, user-defined, number of impressions.

In step 702 a sample's future weight is predicted given 1) its current weight from the stratified sampling in step 701 and 2) historic data capturing changes in supply quantity for each campaign. Several algorithms, parametric and machine-learned, may be used in forecasting weights. A few such algorithms are described in U.S. patent application Ser. No. 12/242,709, entitled “Displaying Advertising Inventory Estimation”, filed Sep. 30, 2008, inventors Sergei Vassilvikkii et al., which is incorporated by reference herein.

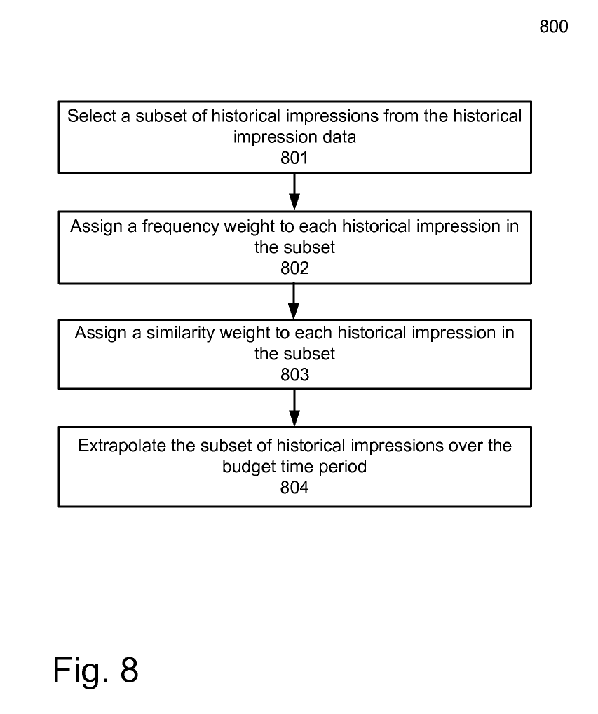

An example algorithm for forecasting these weights is illustrated by the flow diagram 800 depicted in FIG. 8. At step 801, a subset of historical impressions is selected from the historical impression data. The subset may correspond to any length or period of time from the past. At step 802, a frequency weight is assigned to each historical impression in the subset. The frequency weights correspond to the frequency with which each impression occurs within the historical data. At step 803, a similarity weight is assigned to each historical impression. The similarity weights correspond to degrees of similarity between each of the historical impressions and the remaining impressions within the historical impression data. Some impressions may be very similar to the type of impression generally seen in the advertising campaign whereas other impressions may be highly divergent from the norm. Any technique for determining similarity may be used without deviating from the spirit or scope of the impression. At step 804, the subset of historical impressions is extrapolated over the budget time period. Any technique for forecasting weights may be used without deviating from the spirit or scope of the invention.

In steps 703 and 704, annotation is performed use machine learning feature-based models that, respectively, predict action-rate probabilities and prices. Any such model may be used without deviating from the spirit or scope of the invention. Step 705 uses a parametric model based on the input price distributions.

Based on the campaign definition (goal values) and the action rates, a value per impression v can be generated for each sample. Based on the first bid and reserve price estimates, estimates for p can be constructed. If the first bid is a point estimate, then p is simply the maximum of the first bid and reserve price estimates. Otherwise, if the first bid is represented as a distribution F, then the win distribution W can be constructed such that:

$$W ( p ) = \{ \begin{matrix}0 , & if p < r \\ F ( p ) , & otherwise ,\end{matrix} \qquad ( Equation 6 )$$

where r is the reserve-price estimate. Therefore for point prices, the technique uses the set of samples

ζ={(qᵢ,vᵢ,λᵢ,pᵢ)}ᵢ₌₁^{N}, (Equation 7)

and for distributional prices, the technique uses the set of samples

ζ={(qᵢ,vᵢ,λᵢ,Wᵢ(p))}ᵢ₌₁^{N}, (Equation 8)

where q is the quantity of supply of this type.

Given ζ, Monte Carlo estimates of the spend curve may be constructed. For point prices,

$$S ( {b}^{*} ) = {\sum }_{i = 1}^{N} {q}_{i} {1}_{\{ {λ}_{i} b ( {v}_{i} , {λ}_{i} ; {b}^{*} ) \} \geq {p}_{i}} {p}_{i} , \qquad ( Equation 9 )$$

where 1 is the indicator function. For distribution prices,

$$S ( {b}^{*} ) = {\sum }_{i = 1}^{N} {q}_{i} {\int }_{0}^{{λ}_{i} b ( {v}_{i} , {λ}_{i} ; {b}^{*} )} p d {W}_{i} ( p ) . \qquad ( Equation 10 )$$

Thus, S(b*) is simply the summation over each sample, whether point or distributional prices. When the samples are constructed, each campaign may match up to hundreds of thousands of samples. In addition, there may be hundreds of thousands of campaigns over which to optimize.

Because of the additive nature of the spend curve, the unit interval can simply be partitioned into M pieces and, for each sample, its contribution to the curve at each of the M points can be computed. Because the curve is monotonic, a simple binary search algorithm can be used to find the optimal b*.

According to one series of embodiments, the steps described above are executed as offline processes. The output is a single bid parameter (b*) per campaign. In the online system, a bid generation server (BGS) constructs a bid for each matching campaign from the action-rate predictions (λs), campaign definition (goals and maximum bids), and the bid parameter (b*) according to Equation 4. In one such embodiment, the steps occur asynchronously. For instance, a campaign table, which contains the goals and maximum bid information, may be updated frequently (perhaps every 15 minutes), whereas the sampling process much less so (perhaps daily). Any technique for executing asynchronous operations may be used without deviating from the spirit or scope of the embodiments described herein.

This may present a synchronization issue; a b* value is desired that ensures that the online campaign definition is the same version as was used in optimization. However, changes in campaign definitions that are incorporated on a relatively short timescale must be supported. To facilitate this check, a checksum is introduced that hashes relevant campaign definition values. This value is stored in a campaign index accessible to the bid generation server. In addition, the checksum used to optimize the campaign is stored in a parameter index. When both the campaign index checksum and the parameter index checksum coincide, a bid is placed according to Equation 4. When the checksums do not match, a bid is placed according to a default bidding strategy (b*=1).

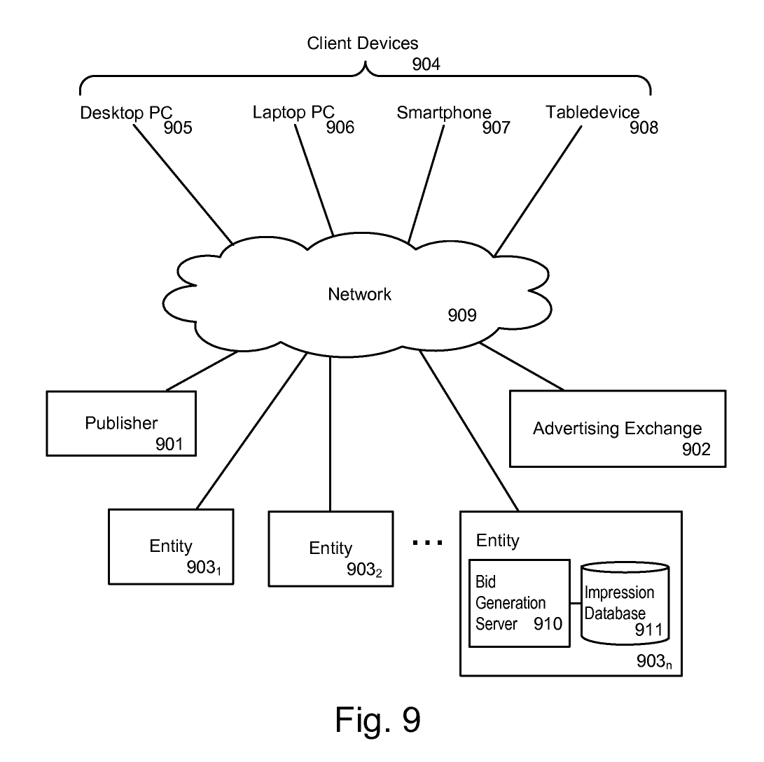

An exemplary environment within which some embodiments of the invention may operate is illustrated in FIG. 9. The diagram 900 of FIG. 9 depicts a Publisher 901, an Advertising Exchange 902, a series of Entities 903₁ to 903ₙ, and a series of client devices 904. The Client Devices 904 may include a Desktop PC 905, a Laptop PC 906, a Smartphone 907, a Tablet Device 908, or any other device capable of receiving an Internet advertisement. Each of the various components connect to Network 909. Network 909 may comprise any combination of networks including, without limitation, the web (i.e. the Internet), a local area network, a wide area network, a wireless network, a cellular network, etc. Network 909 includes signals comprising data and commands exchanged by and among Publisher 901, Advertising Exchange 902, Entities 903₁ to 903ₙ, and Client Devices 904. Entities 903 may include advertisers, advertising networks, brokers, integrator networks, or any other organization seeking to purchase advertising on its own behalf or on behalf of a third party. Each of the Entities 903 may include a Bid Generation Server 910 and an Impressions Database 911.

According to one series of embodiments, one of the Client Devices 904 requests a webpage from Publisher 901. The web page may include an advertising impression sold by Advertising Exchange 902. The impression includes attributes indicating various characteristics such as web page content, user demographic, etc. This impression arrives at Advertising Exchange 902, from which it is transmitted to Entities 903. Entities 903 formulate a bid for the impression using the procedures of various embodiments disclosed herein and transmit the bid to Advertising Exchange 902. The steps for formulating the bid are executed in Bid Generation Server 910 using data stored in Impression Database 911. When all of the bids are received by Advertising Exchange 902, a winning bid is selected and an advertisement corresponding to the entity from among Entities 903 that submitted the winning bid is transmitted to Publisher 901. Publisher 901 incorporates the advertisement into the web page and transmits the web page to the client device from among Client Devices 904 that requested the web page.

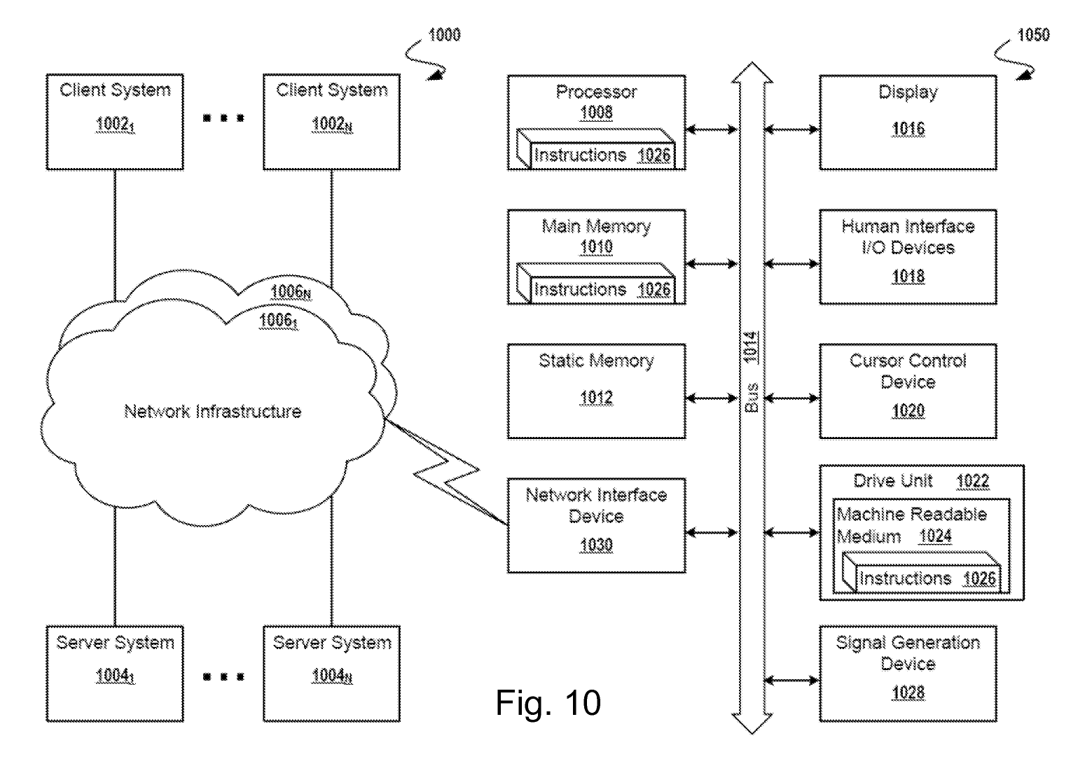

FIG. 10 is a diagrammatic representation of a network 1000, including nodes for client computer systems 1002₁ through 1002_{N}, nodes for server computer systems 1004₁ through 1004_{N}, nodes for network infrastructure 1006₁ through 1006_{N}, any of which nodes may comprise a machine 1050 within which a set of instructions for causing the machine to perform any one of the techniques discussed above may be executed. The embodiment shown is purely exemplary, and might be implemented in the context of one or more of the figures herein.

Any node of the network 1000 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1050 includes a processor 1008 (e.g. a processor core, a microprocessor, a computing device, etc), a main memory 1010 and a static memory 1012, which communicate with each other via a bus 1014. The machine 1050 may further include a display unit 1016 that may comprise a touch-screen, or a liquid crystal display (LCD), or a light emitting diode (LED) display, or a cathode ray tube (CRT). As shown, the computer system 1050 also includes a human input/output (I/O) device 1018 (e.g. a keyboard, an alphanumeric keypad, etc), a pointing device 1020 (e.g. a mouse, a touch screen, etc), a drive unit 1022 (e.g. a disk drive unit, a CD/DVD drive, a tangible computer readable removable media drive, an SSD storage device, etc), a signal generation device 1028 (e.g. a speaker, an audio output, etc), and a network interface device 1030 (e.g. an Ethernet interface, a wired network interface, a wireless network interface, a propagated signal interface, etc).

The drive unit 1022 includes a machine-readable medium 1024 on which is stored a set of instructions (i.e. software, firmware, middleware, etc) 1026 embodying any one, or all, of the methodologies described above. The set of instructions 1026 is also shown to reside, completely or at least partially, within the main memory 1010 and/or within the processor 1008. The set of instructions 1026 may further be transmitted or received via the network interface device 1030 over the network bus 1014.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

1. A computer-implemented method for formulating a bid on an advertising impression for an advertising campaign, the method comprising:
receiving a budget parameter;
determining a campaign goal type, a campaign payment type, and a payment rate;
formulating a bid policy using the campaign goal type, the campaign payment type, the payment rate, and the budget parameter;
generating sampled impression data from the historical impression data;
generating forecast data using the sampled impression data;
generating at least one expected impression value using the sampled impression data and the forecast data;
generating a spend curve using the expected impression value, the bid policy, and the budget parameter; and
formulating the bid using the spend curve.

2. The computer implemented method of claim 1, wherein the campaign goal type comprises at least one of cost per click (CPC) and cost per action (CPA).

3. The computer implemented method of claim 1, wherein the campaign payment type comprises at least one of cost per impression (CPM), cost per click (CPC), and cost per action (CPA).

4. The computer implemented method of claim 1, wherein generating sampled impression data comprises:
selecting a subset of historical impressions from the historical impression data;
assigning a plurality of frequency weights to the historical impressions, wherein the frequency weights are proportional to a total number of impressions within the historical impression data;
assigning a plurality of similarity weights to the historical impressions, wherein the similarity weights correspond to degrees of similarity of the historical impressions with remaining impressions within the historical impression data; and
extrapolating the subset of historical impressions using a time period for the historical impressions and a budget time period.

5. The computer implemented method of claim 1 wherein the forecast data is generated using a Monte Carlo model.

6. The computer implemented method of claim 1, wherein the bid policy is further formulated using a maximum bid constraint.

7. The computer implemented method of claim 1, further comprising ensuring that the budget parameter is not exceeded by using an online budget management system.

8. The computer implemented method of claim 1, further comprising ensuring that the budget parameter is not exceeded by iteratively solving for an optimal bid policy over time.

9. The computer implemented method of claim 1, wherein the spend curve comprises at least one of point prices and distribution prices.

10. The computer implemented method of claim 1, wherein the bid is formulated using a binary search algorithm.

11. A computer readable medium that stores a set of instructions which, when executed by a computer, cause the computer to execute steps for formulating a bid on an advertising impression for an advertising campaign, the steps comprising:
receiving a budget parameter;
determining a campaign goal type, a campaign payment type, and a payment rate;
formulating a bid policy using the campaign goal type, the campaign payment type, the payment rate, and the budget parameter;
generating sampled impression data from the historical impression data;
generating forecast data using the sampled impression data;
generating at least one expected impression value using the sampled impression data and the forecast data;
generating a spend curve using the expected impression value, the bid policy, and the budget parameter; and
formulating the bid using the spend curve.

12. The computer readable medium of claim 11, wherein the campaign goal type comprises at least one of cost per click (CPC) and cost per action (CPA).

13. The computer readable medium of claim 11, wherein the campaign payment type comprises at least one of cost per impression (CPM), cost per click (CPC), and cost per action (CPA).

14. The computer readable medium of claim 11, wherein generating sampled impression data comprises:
selecting a subset of historical impressions from the historical impression data;
assigning a plurality of frequency weights to the historical impressions, wherein the frequency weights are proportional to a total number of impressions within the historical impression data;
assigning a plurality of similarity weights to the historical impressions, wherein the similarity weights correspond to degrees of similarity of the historical impressions with remaining impressions within the historical impression data; and
extrapolating the subset of historical impressions using a time period for the historical impressions and a budget time period.

15. The computer readable medium of claim 11 wherein the forecast data is generated using a Monte Carlo model.

16. The computer readable medium of claim 11, wherein the bid policy is further formulated using a maximum bid constraint.

17. The computer readable medium of claim 11, further comprising ensuring that the budget parameter is not exceeded by using an online budget management system.

18. The computer readable medium of claim 11, further comprising ensuring that the budget parameter is not exceeded by iteratively solving for an optimal bid policy over time.

19. The computer readable medium of claim 11, wherein the spend curve comprises at least one of point prices and distribution prices.

20. The computer readable medium of claim 11, wherein the bid is formulated using a binary search algorithm.
